(19) United States
(12) Patent Application Publication
(10) Pub. No.: US 2025/0297661 A1
(43) Pub. Date: Sep. 25, 2025

(54) LARGE DISPLACEMENT TUNED MASS DAMPER FOR AN AIRCRAFT

(71) Applicant: The Boeing Company, Arlington, VA (US)

(72) Inventor: Steven Griffin, Kihei, HI (US)

(73) Assignee: The Boeing Company, Arlington, VA (US)

(21) Appl. No.: 18/610,238

(22) Filed: Mar. 19, 2024

(51) Int. Cl. F16F 7/10; F16F 7/104

(52) U.S. Cl. CPC F16F 7/1011; F16F 7/104

(57) ABSTRACT

A tuned mass damper for an aircraft. The tuned mass damper can include a magnetic mass coupled to a spring element that is aligned with gravity, where a bounce frequency of the spring element is less than 20 Hz. The tuned mass damper can also include a conducting material aligned with the magnetic mass and configured to have currents induced therein based on movement of the magnetic mass.

### FIELD OF THE DISCLOSURE

Examples of the present disclosure generally relate to low bounce frequency (for example, less than 10 Hz), large displacement tuned mass dampers (TMD) for an aircraft.

### BACKGROUND OF THE DISCLOSURE

Aircraft are used to transport passengers and cargo between various locations. Numerous aircraft depart from and arrive at a typical airport every day.

To provide comfort to these passengers, and to ensure functioning of aircraft systems, low frequency large displacement tuned mass dampers are utilized in the aircraft. Low frequency vibration absorbers, dampers and isolation systems typically are limited when aligned with gravity. When used herein, the phrase aligned with gravity refers to the mass damper, such as a spring, being positioned such that all of the force of the spring is in the z-axis, or up and down. In particular, all gravitational force (in relation to the earth) is considered downward along the z-axis, where a mass damper aligned with gravity provides a force upward along the z-axis to directly counteract the gravitational force. To this end, the damper does not have an angle to the z-axis.

Any spring mass system has some amount of static sag that is independent of the suspended mass and completely dependent on its bounce frequency. In the presence of gravity the spring mass has a static sag determined by

$${x}_{1} = - \frac{g}{{( 2 π f )}^{2}} ,$$

where g is gravity and f is the bounce frequency in Hz. So, for a bounce frequency of 7 Hz, and taking gravity to be 386 in/s\hat{ }2, the static sag would be around −0.2 inches. Because commercial aerospace tuned mass dampers are designed with flexures supporting a suspended mass, a static sag of 0.2 inches may not be able to accommodate lower frequencies and may become the dominant design constraint. The static stress induced in the flexure by gravity ultimately limits achievable performance of the tuned mass damper (TMD).

Additionally, large static sag makes surface treatments like constrained layer damping relatively difficult to design. Some TMDs use a magnetic damper where energy is converted into heat due to the relative velocity of a magnet in proximity to a conducting medium which either has eddy currents induced in it if it is a solid conductor or current induced and dissipated across a resistance if it is a coiled wire. Typically, the magnet is aligned with the conducting medium to keep it from rubbing and allow the magnet to function repeatedly over a range of motion. While current designs can manage large frequencies such as 30 Hz or more, such designs are typically unable to accommodate smaller frequencies such as less than 20 Hz or less than 10 Hz.

When large motion of a suspended mass is required in a gravity field, it is often necessary to employ a helical tension, compression or combination of springs (like in a car) to perform the spring function in the spring mass damper. However, with respect to a TMD, the flexures ensure linear behavior over a large amplitude range, and they are arranged in a pair to ensure axial motion only of the suspended magnet relative to the coil.

### SUMMARY OF THE DISCLOSURE

A need exists for a tuned mass damper for dampening at low frequencies, including less than 20 Hz, in an aircraft setting.

With those needs in mind, certain examples of the present disclosure provide a tuned mass damper for an aircraft. The tuned mass damper can include a magnetic mass coupled to a spring element that is aligned with gravity, where a bounce frequency of the spring element is less than 20 Hz. As used herein, bounce frequency refers to the frequency or oscillation of a spring with a mass attached thereto as a result of gravity. The tuned mass damper can also include a conducting material aligned with the magnetic mass and configured to have currents induced therein based on movement of the magnetic mass.

In at least one example, the tuned mass damper further can include a first flexure coupled to a first surface of the magnetic mass, the first flexure configured to be pliable in an axial direction to permit axial movement of the magnetic mass, and stiff in a radial direction to prevent radial movement of the magnetic mass. In another example, the first flexure may include at least one arcuate slot configured to increase pliability of the first flexure. In yet another example the tuned mass damper can also include a second flexure coupled to a second surface of the magnetic mass spaced from the first surface, the second flexure configured to be pliable in the axial direction to permit axial movement of the magnetic mass, and stiff in a radial direction to prevent radial movement of the magnetic mass. In an additional example, the bounce frequency of the spring element may be less than 10 Hz. In yet another additional example the tuned mass damper can also include a spring tensioning assembly coupled to the spring element and configured to incrementally tension the spring element. In one example, the spring tension assembly may tension the spring element based on a static sag of the spring caused by the gravity. In another example the spring element may be a coiled spring. In yet another example the tuned mass damper may also include a first support structure that may include a central hub and at least one support arm, the spring element coupled to the central hub. In an additional example, the tuned mass damper can also include a second support structure that may include a central hub aligned with the central hub of the first support structure and at least one support arm, the conducting material coupled to the central hub of the second support structure. In yet another additional example, the tuned mass damper can additionally include a first flexure coupled to the magnetic mass and secured between the at least one support arm of the first support structure and the at least one support arm of the second support structure, and the first flexure may have a central opening that surrounds the spring element. In one example, the tuned mass damper can include a second flexure coupled to the magnetic mass and disposed through the at least one support arm of the second support structure. In yet another example, the conducting material can be coupled to a resistor configured to tune the current induced in the conducting material.

Certain examples of the present disclosure provide a tuned mass damper for an aircraft that can include a magnetic mass within an aircraft coupled to a spring element that is aligned with gravity. The tuned mass damper can also include a conducting material aligned with the magnet mass and configured to have currents induced therein based on movement of the magnetic mass, and a spring tensioning assembly coupled to the spring element and configured to reduce the bounce frequency of the spring element to less than 20 Hz.

In one example the spring tensioning assembly can include a first plate coupled to a second plate spaced from the first plate with at least one coupling member, a support arm extending from the second plate and engaging the magnetic mass, and a spring tensioning device coupled to the support arm to incrementally move the magnetic mass axially. In another example, the spring tensioning assembly can be configured to reduce the bounce frequency of the spring element to less than 10 Hz. In yet another example, the spring tensioning assembly can be configured to incrementally adjust the bounce frequency of the spring element between 7 Hz and 10 Hz. In an additional example, the tuned mass damper can additionally include a first flexure that can be coupled to the magnetic mass, the first flexure may be configured to be pliable in an axial direction to permit axial movement of the magnetic mass, and stiff in a radial direction to prevent radial movement of the magnetic mass.

Certain examples of the present disclosure provide a vibration absorber for an aircraft that can include a mass within an aircraft and coupled to a spring element that is aligned with gravity, wherein a bounce frequency of the spring element is less than 20 Hz. In one example, the aircraft can be a helicopter.

### BRIEF DESCRIPTION OF THE DRAWINGS

FIG. 1 illustrates a perspective front view of an aircraft, according to an example of the present disclosure.

FIG. 2 illustrates a perspective front view of a tuned mass damper, according to an example of the present disclosure.

FIG. 3 illustrates a plan front view of a tuned mass damper, according to an example of the present disclosure.

FIG. 4 illustrates a schematic block flow diagram of a method of dampening, according to an example of the present disclosure.

FIG. 5A illustrates a schematic view of a non-linear spring, according to an example of the present disclosure.

FIG. 5B illustrates a schematic view of a non-linear spring, according to an example of the present disclosure.

FIG. 5C illustrates a schematic view of a graph of spring force compared to spring displacement, according to an example of the present disclosure.

FIG. 6 illustrates a schematic diagram of a tuned mass damper, according to an example of the present disclosure.

FIG. 7 illustrates a schematic diagram of a vibration absorber, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

An aircraft uses a tuned mass damper (TMD) that allows linear behavior and performance of a low bounce frequency device in a gravity field. A helical spring stores most of the potential energy in the TMD, while the TMD also has lightweight flexures that are very soft axially but very compliant axially. The flexures ensure that a mass (for example, a magnet) moves precisely relative to the conducting medium and the helical spring accommodates the static sag. The flexures can undergo a large amount of deflection without breaking, because they can be made thin and do not carry axial load. Alternately, the flexures can be installed after the helical spring has deformed in a gravity field, so that they are not deformed in operation.

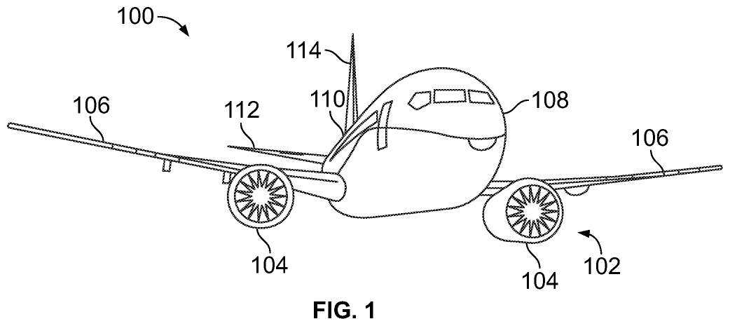

FIG. 1 illustrates a perspective front view of an aircraft 100, according to an example of the present disclosure. The aircraft 100 includes a propulsion system 102 that includes engines 104, for example. Optionally, the propulsion system 102 may include more engines 104 than shown. The engines 104 are carried by wings 106 of the aircraft 100. In other examples, the engines 104 may be carried by a fuselage 108 and/or an empennage 110. The empennage 110 may also support horizontal stabilizers 112 and a vertical stabilizer 114. The fuselage 108 of the aircraft 100 defines an internal cabin 120, which includes a flight deck or cockpit, one or more work sections (for example, galleys, personnel carry-on baggage areas, and the like), one or more passenger sections (for example, first class, business class, and coach sections), one or more lavatories, and/or the like. FIG. 1 shows an example of an aircraft 100. It is to be understood that the aircraft 100 can be sized, shaped, and configured differently than shown in FIG. 1.

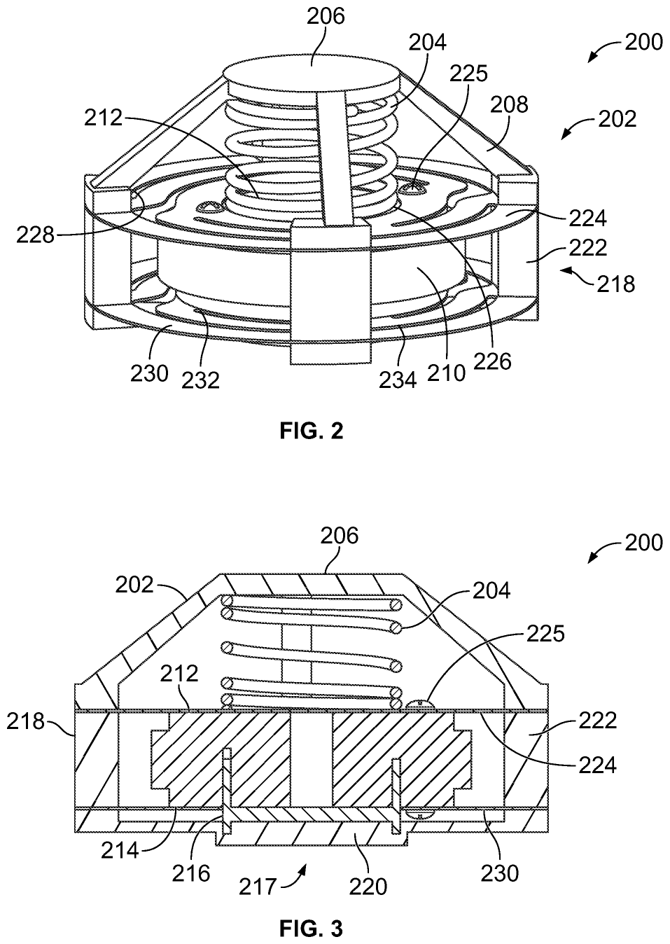

FIG. 2 illustrates a perspective view of a TMD 200, while FIG. 3 illustrates a plan view of the TMD 200. The TMD 200 is designed to provide dampening at low bounce frequencies, including less than 20 Hz and less than 10 Hz. The TMD 200 includes a first support structure 202 that is coupled to a spring element 204. The first support structure 202 can include a central hub 206 that couples to the spring element 204 and numerous support arms 208 that extend downwardly from and around the hub.

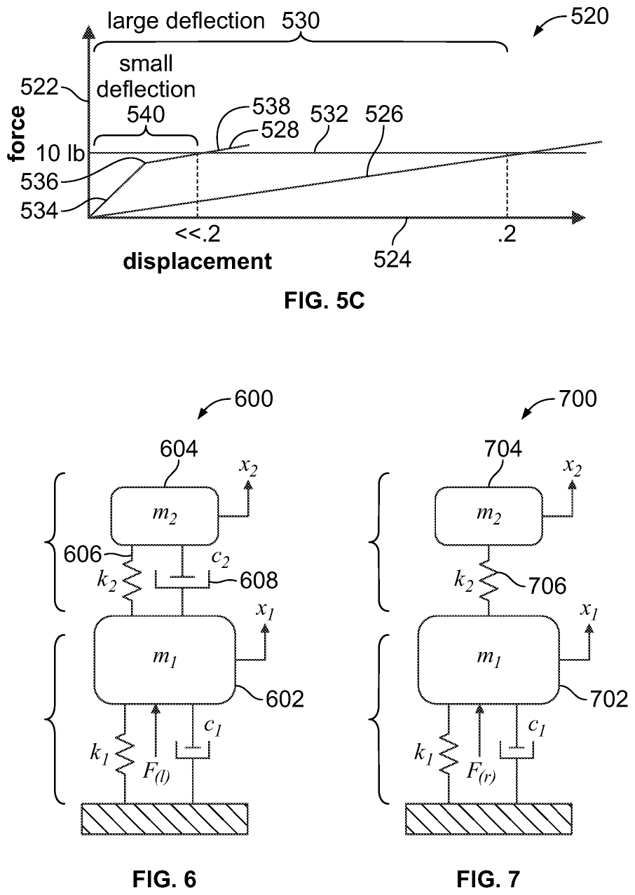

The spring element 204 in one example can be a linear spring such as a helical spring. Alternatively, the spring element 204 may be a non-linear spring (See FIG. 5A-5C). The spring element 204 is coupled to a magnetic mass 210 that is suspended by the spring element 204. The spring element 204 couples to a central portion of the magnetic mass to provide an axial (e.g., up and down force) on the magnetic mass 210. The spring element 204 is coupled at the central portion to reduce or eliminate radial (e.g., side-to-side) movement of the magnet mass. Such radial movement reduces efficiencies of the damper while increasing wear on the spring element 204.

The spring element 204 is tensioned to counteract the force of gravity. While in this example embodiment the spring element 204 is tensioned to counteract the force of gravity, in other examples the TMD 200 could similar be utilized to counteract large static acceleration such as a high G (gravity) force environment. When used herein tensioning refers to the stiffness of the spring. In particular, according to Hooks law, the force needed to extend or compress a spring is equal to kx (e.g., F=kx), where k is a constant that represents the stiffness of the spring and x is the distance the spring moves. So, the constant for the spring element 204 is determined based on the gravitational force on the magnetic mass 210 to counteract the static sag of the magnetic mass 210. In this manner, the magnetic mass 210 only moves as a result of external forces, and not gravitation forces. While in the figures illustrated the spring element 204 is above the magnetic mass 210 such that the magnetic mass 210 acts to pull or extend the spring element 204, in other example embodiments the spring element 204 can be below the magnetic mass 210 such that the magnetic mass 210 compresses the spring element. In yet another example the spring element 204 could have an upper spring element portion above the magnetic mass 210 and a lower spring element portion below the magnetic mass 210. Regardless of the position of the spring element 204 to the magnetic mass 210, the spring element 204 is tensioned to counteract or account for gravitational force on the magnetic mass 210.

The magnetic mass 210 is made from a magnet material. In one example the magnetic material can include super earth magnetic material. The magnetic mass includes a first surface 212 that can be considered an upper surface and a second surface 214 that can be considered a lower surface. In one embodiment the spring element 204 engages and can be secured to the first surface 212. The magnetic mass 210 may be generally cylindrical to facilitate induction of current within a conducting medium 216.

A spring tensioning assembly 217 can be formed between the magnet mass 210 and the conducting medium 216. The conducting medium 216 is coupled to, including within, the magnetic mass 210. To this end, the conducting medium may engage the second surface 214 of the magnetic mass 210. In one example, the conducting medium 216 can be a solid conductor. In another example the conducting medium is a coiled wired. The conducting medium 216 is configured to be formed from a metal that can have eddy currents induced therein, or current induced therein and dissipated across a resistance. In example embodiments when the conducting medium 216 is a coiled wire, a resistor can be coupled to the end of the coiled wire. As a result, by changing or varying the resistance of the coiled wire the amount of current going through the coiled wire can be changed or varied. Because voltage remains constant, there is a direct relationship between the resistance and current going through the coiled wire. As such, by varying the resistance, the current can be proportionately varied to control the amount of energy absorbed by the TMD 200, or tension forces of the spring element 204. Thus, the mass damper is considered tunable. In this manner the resistor can be utilized to determine the damping coefficient of the TMD 200. This tuning allows the spring tensioning assembly 217 to incrementally adjust the bounce frequency of the spring element. In one example the bounce frequency of the spring element may be adjusted between 7 Hz and 10 Hz. In another example the bounce frequency of the TMD can be less than 20 Hz. In another example the bounce frequency of the TMD can be less than 10 Hz. Alternatively, instead of utilizing a coiled wire that is tunable with a resistor, a conductive material, such as copper, can be utilized that is not tunable.

The conducting medium 216 may engage a second support structure 218. The second support structure 218, similar to the first support structure 202 includes a central hub 220 and numerous support arms 222 that extend outwardly from the central hub 220. The conducting medium 216 can engage the central hub 220 of the second support structure.

Disposed between the first support structure 202 and the second support structure 214 is a first flexure 224. In one example the first flexure 224 engages both the first support structure 202 and the second support structure 218 and is secured therebetween. Alternatively, the first flexure 224 engages and/or is secured to only one of the first support structure 202 or second support structure 218.

The first flexure 224 engages and is secured to the first (i.e., top) surface 212 of the magnetic mass 210. In one example a fastener 225 secures the first flexure to the first surface 212 of the magnetic mass 210. The first flexure 224 includes a central opening 226 of size and shape to accommodate the outer diameter of the spring element 204. The primary function of the first flexure 224 is to prevent radial and/or angular movement of the magnetic mass 210 during operation. In particular, because of the use of the spring element 204 to counteract gravitational forces, the first flexure can be made to be exceedingly thin (e.g., less than 2 mm in thickness) compared to the diameter of the first flexure 224. In particular, the first flexure 224 is generally circular in shape. By being exceedingly thin the first flexure is pliable in the axial direction allowing for movement upwardly and downwardly without breaking as the magnetic mass 210 moves upwardly and downwardly. Meanwhile, because of the large diameter, the first flexure 224 is stiff and greatly resists radial forces of the magnetic mass 210. This stiffness reduces, if not eliminates the radial and/or angular forces of the magnetic mass 210.

The first flexure 224 can also have numerous arcuate slots 228 disposed therethrough. The arcuate slots 228 are configured to increase axial pliability and flexibility, while only minimally reducing the radial and/or angular stiffness of the first flexure. By increasing the pliability and/or flexibility the first flexure 224 can deflect to allow axial movement of the magnetic mass 210. In addition, the arcuate slots reduce the amount of material and weight of the first flexure 224 providing additional mechanical advantages.

A second flexure 230 can also be provided that is coupled to and secured to the second (bottom) surface 214 of the magnetic mass 210. Similar to the first flexure 224, the second flexure can be generally circular and thin, providing pliability and flexibility in the axial direction while providing stiffness in the radial direction. In particular, by having the second flexure 230 spaced from the first flexure 224, radial and/or angled motion of the magnetic mass 210 is restrained, or prevented, by aligning the first and second flexures 224, 230. In this manner, if one of the flexures still allows some angular, and/or radial movement, the second flexure functions to correct the first flexure to prevent the angular and/or radial movement. Like the first flexure 224, the second flexure can be secured to the magnetic mass 210 with a fastener 225, have a centrally located openings 232 and include arcuate slots 234. In this manner, both the first flexure 224 and the second flexure function to permit axial movement of the magnetic mass 210 while resisting radial movement of the magnetic mass 210. As such the magnetic mass 210 remains aligned with the conducting medium 216 during operation.

In all, by having both the spring element 204 used in combination with the first flexure 224 and the second flexure 230 a large percentage of the spring energy (e.g., potential energy) in the TMD 200 can be stored in the spring element 204 instead of the first flexure 224 and second flexure 230. In one example at least 90% of the spring energy of the TMD 200 is stored in the spring element 204. In another example at least 95% of the spring energy of the TMD 200 is stored in the spring element. By having the spring energy stored in the spring element 204, the first flexure 224 and second flexure 230 can be designed to be thin and have the main function of preventing radial and/or angular movement of the magnetic mass 210 while the TMD 200 has a low bounce frequency (e.g., less than 10 Hz). To this end, by having two spaced apart flexures 224, 230 ensures alignment of the magnetic mass 210, further reducing radial and/or angular forces.

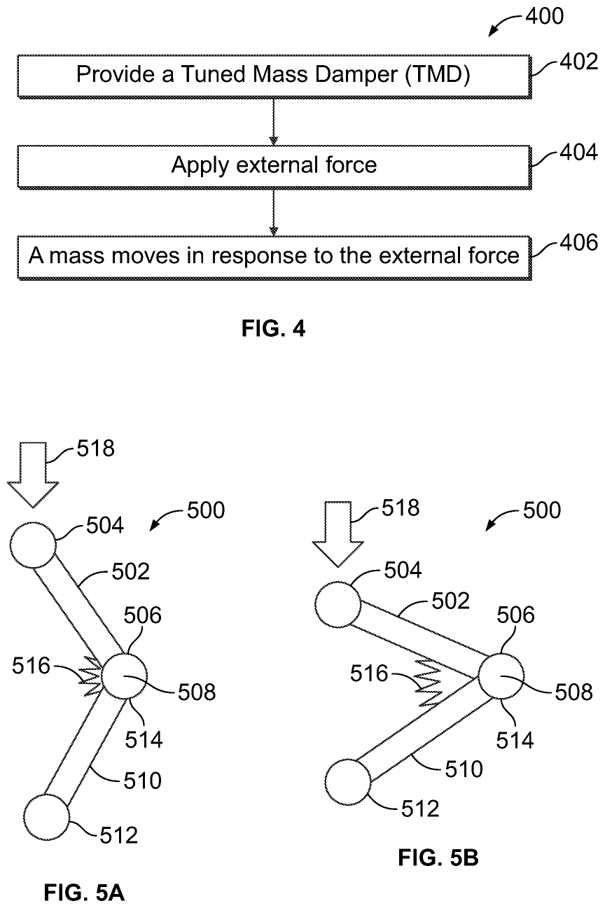

FIG. 4 illustrates a method 400 for dampening forces of an aircraft utilizing a TMD with a low bounce frequency. In one example the bounce frequency is less than 20 Hz. In another example the bounce frequency is less than 10 Hz. In one example the TMD of FIGS. 2 and 3 is utilized to accomplish the operations provided in relation to FIG. 4.

At 402, a TMD is provided that includes a spring element coupled to a mass that has a spring force that is equal to, or nearly equal to, the gravitational force on the mass. By having the spring element account for gravitational forces, static sag of the TMD is eliminated.

At 404, an external force is applied to the TMD. In particular, during a flight of an aircraft, during landing, etc. external forces can be applied that need to be damped. At 406, in response to the external force, the mass moves in an axial (e.g., up and down) while at least one flexure resists radial movement of the mass. The flexure is designed to be pliant or flexible in the axial direction so that the flexure moves with the mass. Meanwhile, in the radial direction the flexure is stiff to resist and prevent radial movement of the mass. When the mass is a magnetic mass, by resisting the radial movement the magnetic mass can remain aligned with a conducting medium to keep it from rubbing the conducting medium and to allow magnetic mass to function repeatedly over its range of motion. In this manner the external force is damped.

FIGS. 5A-B illustrate an alternative type of spring that can be utilized by the TMD of FIGS. 2-4 to resist movement by the magnetic mass. In particular, FIGS. 5A-B illustrate a non-linear spring 500 that can provide a non-linear spring force on a mass. In the example illustrated a first member 502 extends from a first end 504 to a second end 506. At the second end 506 a pivot point 508 is provided such that the second end 506 of the first member 502 couples to a second member 510. The second member 510 also extends from a first end 512 to a second end 514 that is at the pivot point 508 to couple with the second end 506 of the first member 502. A spring 516 is then coupled between the first member 502 and second member 510. In one example the spring 516 is secured to the first member 502 and second member 508. In this manner, when a force 518 is applied to the first end 504 of the first member 502 the spring 516 provides a first force rate as the spring 516 displaces until reaching an inflection point where the spring essentially buckles and provides a second force rate thereafter. Because the spring 516 provides two different spring force rates, a non-linear spring 500 is provided.

The forces as described resulting from the non-linear spring 500 are illustrated in FIG. 5C. FIG. 5C presents a graph 520 of spring force 522 and a corresponding displacement 524 of a linear spring 526 compared to a non-linear spring 528. As illustrated, the displacement of the linear spring 526 is proportional to the force such that a large deflection 530 of the spring is required to reach a determined force threshold 532 (here 10 lbs). In contrast, the non-linear spring 528 provides a first proportional spring force to a displacement component 534 until reaching an inflection point 536, at which point a second proportional spring force displacement component 538 that has a different slope than the first proportional spring force displacement component 534 is provided. This allows a small deflection 540 of the spring to achieve the same determined force threshold 532.

For example, if a heavy weight (force 518) is placed on the first end 504 of the first member 502 (FIG. 5A), at first the spring 516 is very stiff, then it buckles to the position illustrated in FIG. 5B and gets soft. As used herein stiffness (K) refers to a measure of the resistance of the spring, or the force (F) to cause a unit deformation (y) wherein K=Fy. In addition, when referring to a spring as soft, such description is related to the stiffness of the spring. In particular, the spring 516 supports the gravity load but does not deflect as much as it would if it were a linear spring of a low stiffness and then buckles and becomes soft allowing a low bounce frequency. In addition, when the slope (in FIG. 5C) is steep, the stiffness is high and when the slope is shallow, the stiffness is low. In this manner, in the embodiment illustrated in FIGS. 5A-5C when the non-linear spring 500 undergoes the force 518 (FIG. 5A to FIG. 5B) the non-linear spring 500 reaches an equilibrium point as shown in FIG. 5B. In watching the non-linear spring 500 deflect the initial stiffness appears high and as the force is increased, the non-linear spring 500 becomes less stiff. As a result of being less stiff at equilibrium (FIG. 5B), a low bounce frequency is achieved.

FIGS. 6 and 7 illustrate schematic diagrams of a TMD 600 and a vibration absorber 700. To this end, the TMDs as described in relation to FIGS. 1-5 can each function as a vibration absorber. In particular, a TMD 600 couples to a host structure 602 such as an airplane to absorb energy resulting from movement of host structure 602. As a result the TMD includes a mass 604, a spring element 606, and an energy absorber 608. The TMD 600 is for use in commercial aircraft when forces are random, or not cyclical. In contrast, the vibration absorber 700 couples to a host structure 702 and does not absorb energy. Instead, only a mass 704 and spring element 706 are provided and the mass 704 of the vibration absorber 700 can move or slide relative to the host structure. The movement of the mass 704 of the vibration absorber 700 cancels out harmonics resulting in vibration absorption. In particular, a vibration absorber 700 can be utilized by aircraft such as helicopters where vibration is caused by a rotational force of a helicopter rotor that is cyclical or has a pattern and is not random. As such, both the TMD 600 and vibration absorber 700 use structures as described herein that can be utilized to dampen or reduce vibrations on an aircraft.

Further, the disclosure comprises examples according to the following clauses:
Clause 1. A tuned mass damper for an aircraft, the tuned mass damper comprising: a magnetic mass coupled to a spring element that is aligned with gravity, wherein a bounce frequency of the spring element is less than 20 Hz; and a conducting material aligned with the magnetic mass and configured to have currents induced therein based on movement of the magnetic mass.
Clause 2. The tuned mass damper of clause 1, further comprising a first flexure coupled to a first surface of the magnetic mass, the first flexure configured to be pliable in an axial direction to permit axial movement of the magnetic mass, and stiff in a radial direction to prevent radial movement of the magnetic mass.
Clause 3. The tuned mass damper of clause 2, wherein the first flexure includes at least one arcuate slot configured to increase pliability of the first flexure.
Clause 4. The tuned mass damper of clause 2, further comprising a second flexure coupled to a second surface of the magnetic mass spaced from the first surface, the second flexure configured to be pliable in the axial direction to permit axial movement of the magnetic mass, and stiff in a radial direction to prevent radial movement of the magnetic mass.
Clause 5. The tuned mass damper of clause 1, wherein the bounce frequency of the spring element is less than 10 Hz.
Clause 6. The tuned mass damper of clause 1, further comprising a spring tensioning assembly coupled to the spring element and configured to incrementally tension the spring element.
Clause 7. The tuned mass damper of clause 6, wherein the spring tension assembly tensions the spring element based on a static sag of the spring caused by the gravity.
Clause 8. The tuned mass damper of clause 1, wherein the spring element is a coiled spring.
Clause 9. The tuned mass damper of clause 1, further comprising a first support structure including a central hub and at least one support arm, the spring element coupled to the central hub.
Clause 10. The tuned mass damper of clause 9, further comprising a second support structure including a central hub aligned with the central hub of the first support structure and at least one support arm, the conducting material coupled to the central hub of the second support structure.
Clause 11. The tuned mass damper of clause 10, further comprising a first flexure coupled to the magnetic mass and secured between the at least one support arm of the first support structure and the at least one support arm of the second support structure, and the first flexure having a central opening that surrounds the spring element.
Clause 12. The tuned mass damper of clause 11, further comprising a second flexure coupled to the magnetic mass and disposed through the at least one support arm of the second support structure.
Clause 13. The tuned mass damper of clause 1, wherein the conducting material is coupled to a resistor configured to tune the current induced in the conducting material.
Clause 14. A tuned mass damper for an aircraft comprising: a magnetic mass within an aircraft coupled to a spring element that is aligned with gravity; a conducting material aligned with the magnet mass and configured to have currents induced therein based on movement of the magnetic mass; and a spring tensioning assembly coupled to the spring element and configured to reduce the bounce frequency of the spring element to less than 20 Hz.
Clause 15. The tuned mass damper of clause 14, the spring tensioning assembly comprising: a first plate coupled to a second plate spaced from the first plate with at least one coupling member; a support arm extending from the second plate and engaging the magnetic mass; and a spring tensioning device coupled to the support arm to incrementally move the magnetic mass axially.
Clause 16. The tuned mass damper of clause 14, wherein the spring tensioning assembly is configured to reduce the bounce frequency of the spring element to less than 10 Hz.
Clause 17. The tuned mass damper of clause 14, wherein the spring tensioning assembly is configured to incrementally adjust the bounce frequency of the spring element between 7 Hz and 10 Hz.
Clause 18. The tuned mass damper of clause 14, further comprising a first flexure coupled to the magnetic mass, the first flexure configured to be pliable in an axial direction to permit axial movement of the magnetic mass, and stiff in a radial direction to prevent radial movement of the magnetic mass.
Clause 19. A vibration absorber for an aircraft comprising: a mass within an aircraft and coupled to a spring element that is aligned with gravity, wherein a bounce frequency of the spring element is less than 20 Hz.
Clause 20. The vibration absorber of clause 19, wherein the aircraft is a helicopter.

As described herein, examples of the present disclosure provide systems and methods for effectively and efficiently estimating a fuel level for a flight of an aircraft. Further, examples of the present disclosure provide systems and methods for accurately accounting for aeroelastic effects due to changing fuel levels during a flight of an aircraft. Additionally, examples of the present disclosure also provide systems and methods for determining fuel level estimates based on all phases (including climb, cruise, and descent) of a flight.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A tuned mass damper for an aircraft, the tuned mass damper comprising:
a magnetic mass coupled to a spring element that is aligned with gravity, wherein a bounce frequency of the spring element is less than 20 Hz; and
a conducting material aligned with the magnetic mass and configured to have currents induced therein based on movement of the magnetic mass.

2. The tuned mass damper of claim 1, further comprising a first flexure coupled to a first surface of the magnetic mass, the first flexure configured to be pliable in an axial direction to permit axial movement of the magnetic mass, and stiff in a radial direction to prevent radial movement of the magnetic mass.

3. The tuned mass damper of claim 2, wherein the first flexure includes at least one arcuate slot configured to increase pliability of the first flexure.

4. The tuned mass damper of claim 2, further comprising a second flexure coupled to a second surface of the magnetic mass spaced from the first surface, the second flexure configured to be pliable in the axial direction to permit axial movement of the magnetic mass, and stiff in a radial direction to prevent radial movement of the magnetic mass.

5. The tuned mass damper of claim 1, wherein the bounce frequency of the spring element is less than 10 Hz.

6. The tuned mass damper of claim 1, further comprising a spring tensioning assembly coupled to the spring element and configured to incrementally tension the spring element.

7. The tuned mass damper of claim 6, wherein the spring tension assembly tensions the spring element based on a static sag of the spring caused by the gravity.

8. The tuned mass damper of claim 1, wherein the spring element is a non-linear spring that is configured to provide a first stiffness for a first displacement when the mass is at a first position resulting in a first force caused by the mass and the gravity and a second stiffness for a second displacement when the mass is at a second position resulting in a second force caused by the mass and the gravity, wherein the first stiffness is greater than the second stiffness.

9. The tuned mass damper of claim 1, further comprising a first support structure including a central hub and at least one support arm, the spring element coupled to the central hub.

10. The tuned mass damper of claim 9, further comprising a second support structure including a central hub aligned with the central hub of the first support structure and at least one support arm, the conducting material coupled to the central hub of the second support structure.

11. The tuned mass damper of claim 10, further comprising a first flexure coupled to the magnetic mass and secured between the at least one support arm of the first support structure and the at least one support arm of the second support structure, and the first flexure having a central opening that surrounds the spring element.

12. The tuned mass damper of claim 11, further comprising a second flexure coupled to the magnetic mass and disposed through the at least one support arm of the second support structure.

13. The tuned mass damper of claim 1, wherein the conducting material is coupled to a resistor configured to tune the current induced in the conducting material.

14. A tuned mass damper for an aircraft comprising:
a magnetic mass within an aircraft coupled to a spring element that is aligned with gravity;
a conducting material aligned with the magnet mass and configured to have currents induced therein based on movement of the magnetic mass; and
a spring tensioning assembly coupled to the spring element and configured to reduce the bounce frequency of the spring element to less than 20 Hz.

15. The tuned mass damper of claim 14, the spring tensioning assembly comprising:
a first plate coupled to a second plate spaced from the first plate with at least one coupling member;
a support arm extending from the second plate and engaging the magnetic mass; and
a spring tensioning device coupled to the support arm to incrementally move the magnetic mass axially.

16. The tuned mass damper of claim 14, wherein the spring tensioning assembly is configured to reduce the bounce frequency of the spring element to less than 10 Hz.

17. The tuned mass damper of claim 14, wherein the spring tensioning assembly is configured to incrementally adjust the bounce frequency of the spring element between 7 Hz and 10 Hz.

18. The tuned mass damper of claim 14, further comprising a first flexure coupled to the magnetic mass, the first flexure configured to be pliable in an axial direction to permit axial movement of the magnetic mass, and stiff in a radial direction to prevent radial movement of the magnetic mass.

19. A vibration absorber for an aircraft comprising:
a mass within an aircraft and coupled to a spring element that is aligned with gravity, wherein a bounce frequency of the spring element is less than 20 Hz.

20. The vibration absorber of claim 19, wherein the spring element is a non-linear spring that is configured to provide a first stiffness for a first displacement when the mass is at a first position resulting in a first force caused by the mass and the gravity and a second stiffness for a second displacement when the mass is at a second position resulting in a second force caused by the mass and the gravity, wherein the first stiffness is greater than the second stiffness.
